(19) United States
(12) Patent Application Publication
(10) Pub. No.: US 2019/0009537 A1
(43) Pub. Date: Jan. 10, 2019

(54) PRINTHEAD WITH NON-EPOXY MOLD COMPOUND

(71) Applicant: Hewlett-Packard Development Company, L.P., Houston, TX (US)

(72) Inventors: Chien-Hua Chen, Corvallis, OR (US); Michael W. Cumbie, Corvallis, OR (US)

(21) Appl. No.: 15/748,888

(22) PCT Filed: Oct. 13, 2015
(86) PCT No.: PCT/US2015/055247

§ 371 Date: Jan. 30, 2018

(51) Int. Cl. B41J 2/14; B41J 2/155; B41J 2/16

(52) U.S. Cl. CPC B41J 2/14201; B41J 2/155; B41J 2202/20; B41J 2/1637; B41J 2/14129; B41J 2/1601

(57) ABSTRACT

A printhead may include a non-epoxy mold compound layer and a number of slivers overmolded into the non-epoxy mold compound layer. A media wide array may include a number of printhead dies and a layer of moldable material, wherein the moldable material includes a non-epoxy mold compound overmolded onto the number of printhead dies.

### BACKGROUND

Printhead dies may include tiny channels that carry ink to the ejection chambers. Ink is distributed from the ink supply to the die channels through passages in a structure that supports the printhead die(s) on the pen or print bar.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a block diagram of a printing device including a number of slivers overmolded into a non-epoxy mold compound layer according to one example of the principles described herein.

FIG. 2 is an exploded perspective view of a print bar including a number of printhead dies that include a number of slivers overmolded by a non-epoxy mold compound (NEMC) according to one example of the principles described herein.

FIG. 3 is a close-up, cut-away, perspective view of the print bar number of printhead dies including a number of slivers overmolded by a non-epoxy mold compound (NEMC) according to one example of the principles described herein.

FIG. 4 is a flowchart showing a method of making a printhead die including a number of slivers overmolded into the non-epoxy mold compound (NEMC).

FIG. 5 is a close-up, cut-away, perspective view of a printhead including a number of slivers overmolded by a non-epoxy mold compound (NEMC) according to one example of the principles described herein.

FIG. 6 is a perspective view of a media wide array including a number of dies each including a number of slivers overmolded by a non-epoxy mold compound (NEMC) according to one example of the principles described herein.

Throughout the drawings, identical reference numbers designate similar, but not necessarily identical, elements.

### DETAILED DESCRIPTION

As described above, printhead dies may include a number of elements used to transfer an amount of ejection fluid from a printing fluid supply to the small printhead dies from which the printing fluid is ejected onto paper or other print media. In order to save costs in materials used to form the printhead dies, the printhead dies can be reduced in size by reducing the slot pitch (i.e., the width between ink feed slots) and consequently the distance between rows of nozzles. While reducing the size and spacing of the printhead dies continues to be a goal for reducing costs, channeling printing fluid from the larger supply components to ever smaller, more tightly spaced dies uses complex flow structures and fabrication processes that may actually increase the overall cost of forming the printhead dies.

Die slivers may be formed out of silicon and may include a single row of nozzles, firing chambers, and ejection fluid feed slots. This allows each individual row of nozzles to eject its own color or type of ejection fluid while still reducing the width of each sliver and consequently the die formed by a plurality of slivers as well. Each of these slivers may have a thickness of 100 μm or less containing multiple fluid ejectors such as a resistive heating element and multiple fluid ejection chambers with a ratio of length to width of 50 or more. The slivers may be 25 mm long (or longer) and not more than 200 μm wide. A number of these slivers may be combined to form a single printhead die in order to eject multiple colors or types of ejection fluid onto the print media.

In one example, a printhead implementing these slivers may include multiple slivers molded into an elongated, monolithic body of moldable material. Printing fluid channels molded into the body carry printing fluid directly to flow passages in each die. The molding in effect grows the size of each die for making external fluid connections and for attaching the dies to other structures, thus enabling the use of smaller dies. The printhead dies and printing fluid delivery channels can be molded at the wafer level to form a composite printhead wafer with built-in printing fluid channels, eliminating the process of forming the printing fluid channels in a silicon substrate and enabling the use of thinner, longer and narrower dies.

The present specification describes a number of slivers arranged to form a printhead such as a media wide array or a single printhead die. Once arranged, for example, face down, a layer of non-epoxy mold compound (NEMC) may be overmolded over the arranged slivers. In one example, the number of slivers is one. In one example, the number of slivers is more than one. Once overmolded with the NEMC, the overmolded slivers may be placed on a die carrier and assembled with the remaining portions of the print bar. Some examples of the NEMC may include, non-epoxy based thermal set materials, polymide, thermal plastics, glasses (i.e., low melt glasses), silicon alloys, semiconductor materials, ceramics, metal oxides, and metals, among others. Some examples of NEMC plastics may include liquid crystal polymers (LCPs), polyimide (PI), acrylonitrile butadiene styrene and styrene acrylonitrile (ABS & SAN), polycarbonate (PC), polyamide (PA), polymethyl methacrylate (PMMA), polyacetal/polyoxymethylene (POM), polybutylene terephthalate (PBT), polyethylene terephthalate (PET), polyphenylene oxide (PPO/PPE Blends), fluoropolymers (PTFE), polyphenylene sulfide (PPS), and polyketones (PEEK & PEKK), among others.

The present specification further describes a printhead including a non-epoxy mold compound layer and a number of slivers overmolded into the non-epoxy mold compound layer.

The present specification also describes a media wide array may include a number of printhead dies and a layer of moldable material, wherein the moldable material includes a non-epoxy mold compound overmolded onto the number of printhead dies.

The present specification also describes a printhead fabrication method including placing a number of printhead dies face down on a carrier overmolding the printhead dies on the carrier with a non-epoxy mold compound.

As used in the present specification and in the appended claims, the terms “printhead” and “printhead die” are meant to be understood broadly as a part of a printer or other type of dispenser that dispenses ejection fluid from a number of openings or nozzles. Additionally, in the present specification and in the appended claims a die “sliver” or “sliver” is meant to be understood as a portion of a printhead die that, in one example, includes a single row of nozzles and dispenses ejection fluid from a number of those nozzles. In one example, a sliver may have a ratio of length to width of 50 or more. A printhead includes a number printhead dies. The terms “printhead” and “printhead die” are not meant to limit the type of ejection fluid ejected therefrom but instead is meant to include ejection ink as well as other fluids during, for example, a printing process. Additionally a “printhead” or “printhead dies” may be used for other uses other than printing.

Further, as used in the present specification and in the appended claims, the term “epoxy molding compound (EMC)” is broadly defined herein as any materials including at least one epoxide functional group. In one example, the EMC is a self-cross-linking epoxy. In this example, the EMC may be cured through catalytic homopolymerization. In another example, the EMC may be a polyepoxide that uses a co-reactant to cure the polyepoxide. Curing of the EMC in these examples creates a thermosetting polymer with high mechanical properties, and high temperature and chemical resistance.

Still further, as used in the present specification and in the appended claims, the term “non-epoxy molding compound (EMC)” is broadly defined herein as those materials that do not include an epoxide functional group. In a number of examples, the NEMC may include a glass, a plastic, a silicon alloy, a semiconductor material, a ceramic, a metal oxide, a metal, or combinations thereof.

Even still further, as used in the present specification and in the appended claims, the term “a number of” or similar language is meant to be understood broadly as any positive number including 1 to infinity.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

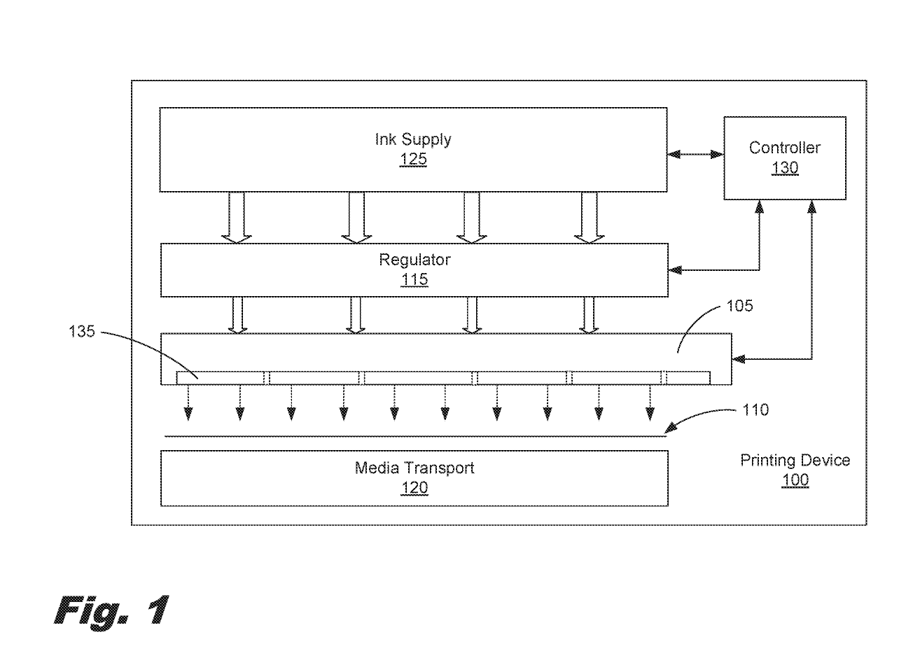

FIG. 1 is a block diagram of a printing device (100) including a number of slivers (135) overmolded into a non-epoxy mold compound layer according to one example of the principles described herein. The printing device (100) may include a print bar (105) that, in one example, spans the width of a print media (110). The printing device (100) may further include flow regulators (115) associated with the print bar (105), a media transport mechanism (120), ink or other ejection fluid supplies (125), and a controller (130). The controller (130) may represent the programming, processor(s), associated data storage device(s), and the electronic circuitry and components used to control the operative elements of a printing device (100). The print bar (105) may include an arrangement of overmolded slivers (135) for dispensing printing fluid onto a sheet or continuous web of paper or other print media (110). The print bar (105) in FIG. 1 includes multiple overmolded slivers (135) spanning print media (110). However, different print bars (105) are contemplated in the present specification that may include more or less overmolded slivers (135) and may be fixed to a media wide array bar as depicted in FIG. 1 or on a movable print cartridge.

In the present specification, any type of digital, high precision liquid dispensing system may utilize these examples in connection with the print bar (105) and slivers (135). For example, printheads formed by the number of slivers (135) may include any two-dimensional (2D) printing elements or devices, any three-dimensional (3D) printing elements or devices, digital titration elements or devices, piezoelectric printing elements or devices, other types of digital, high precision liquid dispensing system, or combinations thereof. These various types of liquid dispensing systems may dispense a myriad of types of liquids including, for example, inks, 3D printing agents, pharmaceuticals, lab fluids, and bio-fluids, among other dispensable liquids. The 3D printing agents may include polymers, metals, adhesives, 3D inks, among others.

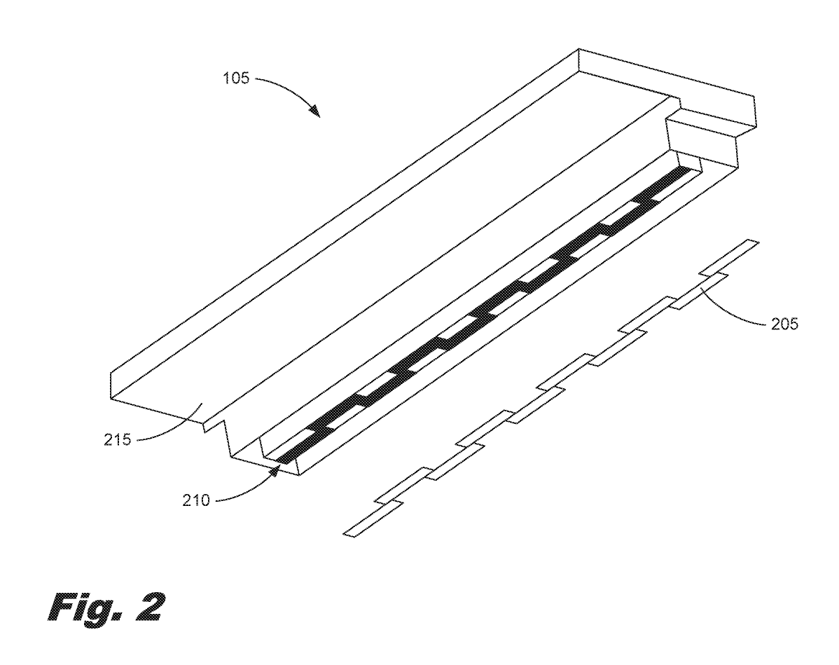

FIG. 2 is an exploded perspective view of a print bar (105) including a number of printhead dies (205) that include a number of slivers overmolded by a non-epoxy mold compound (NEMC) according to one example of the principles described herein. In FIG. 2, multiple printhead dies (205) are arranged in a row lengthwise across the print bar (105) in a staggered configuration in which each printhead die (205) overlaps an adjacent printhead die (205). Each printhead die (205) is mounted to a platform or other suitable mounting structure (210) on a print bar body (215). Although ten printhead dies (205) are shown in a staggered configuration, more or fewer printhead dies (205) may be used and/or arranged in a different configuration. For example, a single printhead die (205) may be used that runs the entire length of the print bar (105). In one example, a single sliver may form a printhead die (205) and may be arranged to run the length of the print bar (105) or overlap other slivers to form an arrangement of slivers along the entire length of the print bar (105).

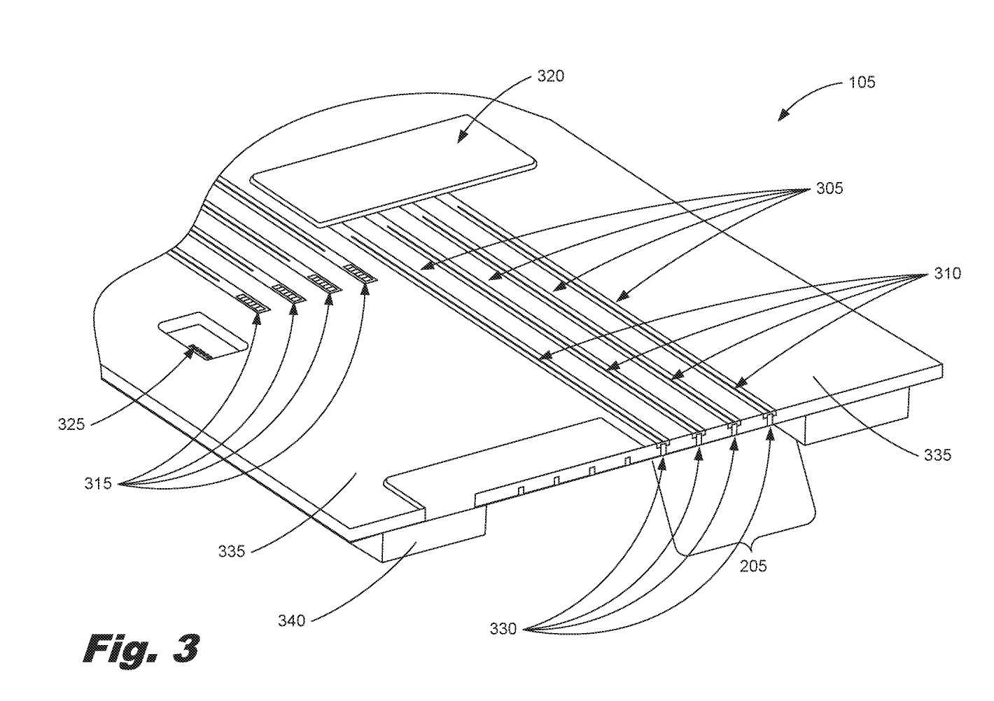

FIG. 3 is a close-up, cut-away, perspective view of the print bar (105) number of printhead dies (205) including a number of slivers (305) overmolded by a non-epoxy mold compound (NEMC) (310) according to one example of the principles described herein. As described above, the print bar (105) may include any number of slivers (305) arranged together to form a number of printhead dies (205). In one example, the number of printhead dies (205) may form a media wide array of printhead dies (205) such that the print bar (105) fully covers a print media (FIG. 1, 110) as the print media (FIG. 1, 110) passes through the printing device (100).

In the example shown in FIG. 3, four slivers (305) form the printhead die; each sliver (305) provided with a distinct color to eject from a number of nozzles (310) defined in each of slivers (305). As will be discussed below, the ejection fluid may be provided to the slivers (135) via a number of ejection fluid feed slots (330) defined in the printhead. Although four slivers (305) are shown as forming a single printhead die (205), the present specification contemplates the use of more or less slivers (305) in order to eject onto a print media (FIG. 1, 110) any type or color of ejection fluid.

Each sliver (305) may further be coupled to an electrical power source via a number of electrical interconnects (315) formed at, in one example, an end of each of the slivers (305). These electrical interconnects (315) form part of an electrical path from the printing device's (FIG. 1, 100) power source to the individual firing chambers defined in the slivers (305) to actuate either a piezoelectric crystal or a resistive heating element. In one example, the electrical interconnects (315) may be covered with an encapsulant (320) as shown in FIG. 3. In the example of FIG. 3, the electrical interconnects (315) may be wired to a bond pad (325) before the encapsulant (320) is placed over the electrical interconnects (315) and bond pad (325).

All of the slivers (305) arranged to form individual printhead dies (205) may be overmolded in non-epoxy mold compound (NEMC) (335). During manufacture, each of the slivers (305) may be so arranged face down such that no NEMC (335) can cover the nozzles of the slivers (305). When the slivers (305) are arranged, the NEMC (335) may be overmolded onto the slivers (305) to retain them in their position. In this example, the upper surface of each of the slivers (305), including the nozzles (310), is flush with the NEMC (335) layer. This results in each printhead die (205) having a flat surface. This may help during any wiping procedure of the printhead die (205) by preventing any contaminants from accumulating in crevices formed between the NEMC (335) layer and the slivers (305). Since the upper surface of the slivers (305) and the NEMC (335) layer are co-planar, no crevices are formed and a wiper may wipe an even surface of the printhead die (205).

In one example, a printed circuit board (340) may be overmolded with NEMC (335) along with the slivers (305) in the same process. In one example, the overmolded slivers (305) may be coupled to the printed circuit board (340) with an adhesive. Other types of molding processes may also be used and the present application contemplates the use of those processes to overmold the slivers (305) and/or printed circuit boards (340) with NEMC (335).

As briefly described above, the NEMC (335) may include a number of non-epoxy-based materials. In one example, the NEMC (335) may be a glass. In this example, the glass may be a low-melt glass. In this example, powder (frit) of the low melt glass can be heated and poured over the slivers (305) or compact molded into a mold holding the slivers (305). In one example, a melting temperature range of the low melt glass is in the temperature range of 250-400° C. In one example, a melting temperature range of the low melt glass is in the range of 300-350° C. In one example, borosilicate glass having the melting temperature in the above-described ranges may be used. In one example, the borosilicate glass may include no less than 50% by weight of PbO as a component. A quantity of ZnO, Al2O3, TiO2, Bi2O3, PbF2, CuO may be included with the low-melt glass. In one example, borosilicate bismuth glass can be used. In one example, these glasses can be used in a combined manner.

In one example, the NEMC (335) may be a thermal plastic such as liquid crystal polymers (LCPs), polyimide (PI), acrylonitrile butadiene styrene and styrene acrylonitrile (ABS & SAN), polycarbonate (PC), polyamide (PA), polymethyl methacrylate (PMMA), polyacetal/polyoxymethylene (POM), polybutylene terephthalate (PBT), polyethylene terephthalate (PET), polyphenylene oxide (PPO/PPE Blends), fluoropolymers (PTFE), polyphenylene sulfide (PPS), polyketones (PEEK & PEKK), or combinations thereof. Each of these plastics may be electrically insulating and resistant to melting when high temperatures are applied to the plastics. In this example, the plastics may resist melting when temperatures produced by, for example, a resistive heating element are experienced at the printhead dies (205) and print bar (FIG. 1, 105) generally.

In one example, the NEMC (335) may be a silicon alloy. In this example, the silicon alloy may include nickel silicon alloys, iron silicon alloys, germanium silicon alloys, aluminum silicon alloys, tin, silicon alloys, and copper silicon alloys.

In one example, the NEMC (335) may be a semiconductor material such as diamond, silicon, germanium, gray tin (∀-Sn), silicon carbide (3C—SiC, 4H—SiC, 6H—SiC), sulfur (∀-S), gray selenium, tellurium, lead telluride (PbTe), Bismuth telluride (Bi₂Te₃), mercury zinc telluride (HgZnSe), among others. The properties of these and other semiconductors may be considered such as thermal conductivity and hardness.

In one example, the NEMC (335) may be a ceramic. Examples of ceramics that can be used as a NEMC (335) may include porcelains and glass ceramics, among others. The type of ceramic chosen may also be dependent on the characteristics desired such as heat resistance and hardness.

In one example, the NEMC (335) may be a metal or metal oxide. Hardness properties of metal oxides and metals may also help in the selection of the NEMC (335).

In one example, the NEMC (335) may be a polymide. With relatively high heat resistance, a polymide may be chosen to resist the thermal heats created by, for example, resistive heating elements within a number of firing chambers defined in the slivers (305). In one example, the polymide may be a thermosetting polymide and may be selected based on characteristics such as thermal stability, chemical resistance to, for example, hydrocarbons, esters, ethers, alcohols, and freons, and mechanical properties such as tensile strength even under temperatures of up to 846 degree Fahrenheit.

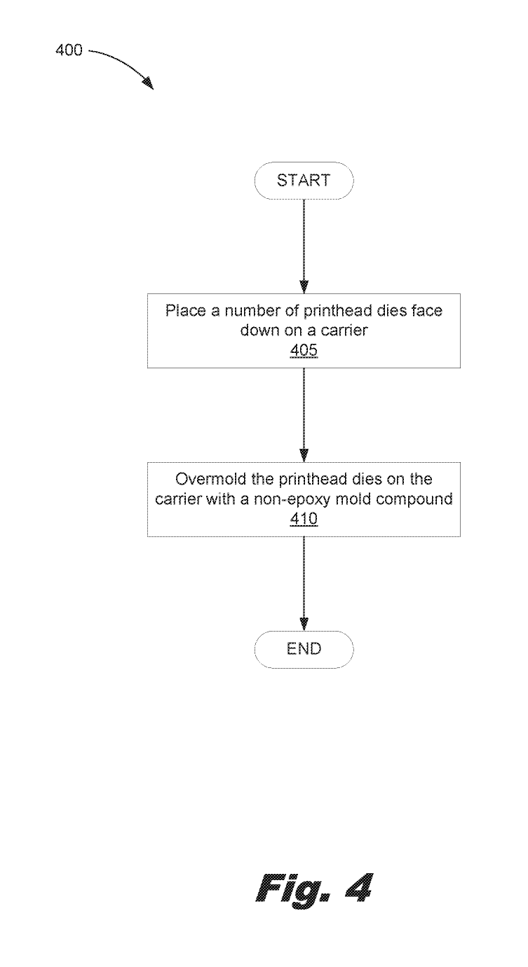

FIG. 4 is a flowchart showing a method (400) of making a printhead including a number of printhead dies (FIG. 2, 205) overmolded into the NEMC (335). The method may begin with placing (405) a number of printhead dies (FIG. 2, 205) and/or a number of slivers (FIG. 3, 305) face down on a carrier. In one example, the printhead dies (FIG. 2, 205) may be placed (405) on a piece of tape or other adhesive placed on a carrier so as to arrange them in a predetermined configuration to form a printhead. In this example, the contact between the face of the printhead dies (FIG. 2, 205) and the tape may seal the area around the printhead dies (FIG. 2, 205) during the molding process as well as maintain the printhead dies (FIG. 2, 205) in the predetermined arrangement.

The method (400) may continue with overmolding (410) the printhead dies (FIG. 2, 205). Continuing with the example described above, a compression overmolding process may include molding the NEMC (FIG. 3, 335) over the printhead dies (FIG. 2, 205). In this example, a mold top may heat the NEMC (FIG. 3, 335) at appropriate locations and force the NEMC (FIG. 3, 335) against the printhead dies (FIG. 2, 205) using pressure force onto all areas within the mold. Because the tape covers the face of the printhead dies (FIG. 2, 205), the face does not get covered with the NEMC (FIG. 3, 335) thereby preventing NEMC (FIG. 3, 335) form entering the nozzles of the individual slivers (FIG. 3, 305) forming the printhead dies (FIG. 2, 205). After the NEMC (FIG. 3, 335) has cured or cooled, the tape and carrier may be removed from the now overmolded printhead dies (FIG. 2, 205) and the overmolded printhead dies (FIG. 2, 205) may be affixed to, for example, a mounting structure (FIG. 2, 210) on a print bar body (FIG. 2, 215).

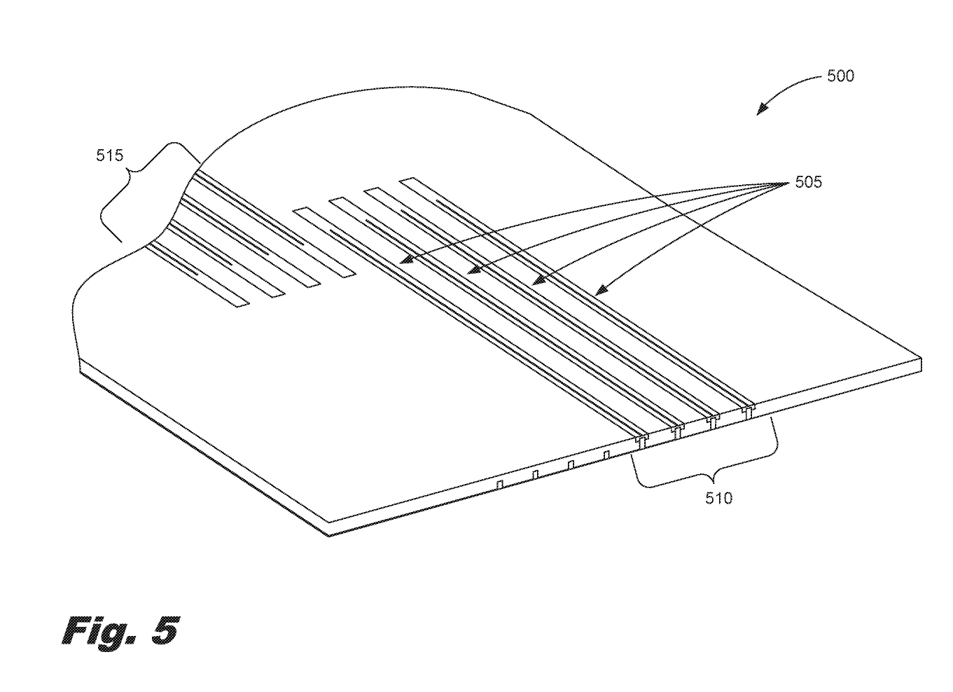

FIG. 5 is a close-up, cut-away, perspective view of a printhead (500) including a number of slivers (505) overmolded by a non-epoxy mold compound (NEMC) according to one example of the principles described herein. As similarly described in connection with FIG. 3, the printhead (500) may include a number of dies (510, 515) with each die (510, 515) including a number of slivers (505). In one arrangement of the dies (510, 515), a first die (510) may overlap, laterally, a second die (515). Consequently, nozzles defined in each of the faces of the slivers (505) for the first die (510) overlap nozzles defined in each of the faces of slivers (505) of the second die (515). In order to prevent too much ejection fluid being ejected from the combination of any overlapping nozzles, the overlapping nozzles may be stitched together. Stitching of the nozzles is accomplished, in one example, by timing the firing of any overlapping nozzles such that the combined firing of ejection fluid from the overlapped nozzles does not eject any more or less ejection fluid than other non-overlapping nozzles. In this example, the controller (FIG. 1, 130) may execute instructions to fire any overlapping nozzles in order to accommodate for this in-line stitching process. The stitching instructions may be operative to cause a first and a second ink nozzle that are overlapping to eject drops of ejection fluid in a certain region of the print media (FIG. 1, 110). In an example, the stitching instructions may be operative to cause the first and second nozzles that are overlapping to adjust the density of ejection fluid ejected from the nozzles. This prevents any visual printing defects from developing on the printed image.

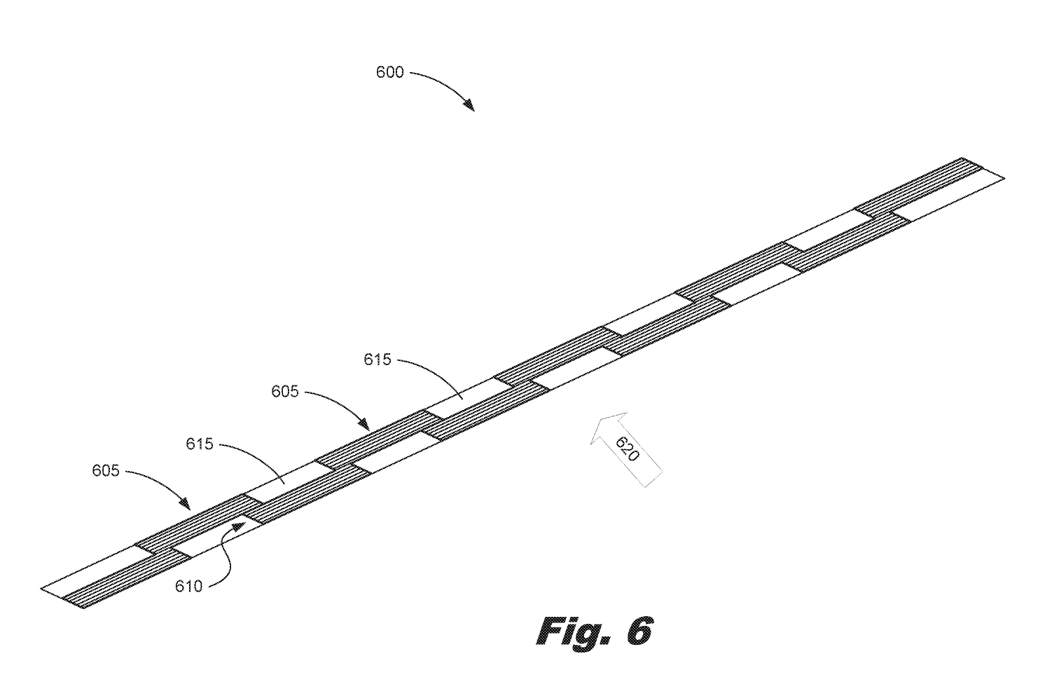

FIG. 6 is a perspective view of a media wide array (600) including a number of dies (605) each including a number of slivers (610) overmolded by a non-epoxy mold compound (NEMC) (615) according to one example of the principles described herein. As described above, the number of dies (605) may form a media wide array of dies (605) such that the array of dies (605) fully covers a print media (FIG. 1, 110) as the print media (FIG. 1, 110) passes through the printing device (100). In the example shown in FIG. 6, the print media (FIG. 1, 110) may be passed the media wide array of dies (605) in the direction of the arrow (620).

The specification and figures describe a printhead with non-epoxy mold compound. Costs associated with manufacturing printing devices has been achieved through shrinking the width of the printhead dies and reducing the cost of wafers used to make the dies. This reduction has progressed to about 10% year-by-year. The ability to further shrink the printhead die has diminished recently because it is getting increasingly difficult to shrink the slot pitch or distance between the rows of nozzles defined in a die further without adding excessive printhead assembly cost associated with integrating such small dies. Furthermore, the die costs a fraction of the overall system cost so it does not make sense to save a few pennies in die cost while adding much more back to the pen assembly cost in order to accommodate a design with tight ink slot pitch. In order to help with reducing the costs associated with the manufacturing of printhead dies, slivers have been developed that can be made to be overmolded by a non-epoxy mold compound (NEMC). The NEMC may include a number of different materials that may reduce the cost of manufacturing while providing a number of different types of materials that take into consideration hardness, thermal conductivity, and other properties of the printhead die. With the myriad of materials described in the present specification, a manufacturer may develop and manufacture a printhead die varying the characteristics of the NEMC to fit different environments and types of slivers used.

The preceding description has been presented to illustrate and describe examples of the principles described. This description is not intended to be exhaustive or to limit these principles to any precise form disclosed. Many modifications and variations are possible in light of the above teaching.

What is claimed is:

1. A printhead comprising:
a non-epoxy mold compound layer; and
a number of slivers overmolded into the non-epoxy mold compound layer, an upper surface of the non-epoxy mold compound layer being flush with an upper surface of the number of slivers.

2. The printhead of claim 1, wherein the non-epoxy mold compound is a glass.

3. The printhead of claim 1, wherein the non-epoxy mold compound is a silicon alloy.

4. The printhead of claim 1, wherein the non-epoxy mold compound is a semiconductor material.

5. The printhead of claim 1, wherein the non-epoxy mold compound is a ceramic.

6. The printhead of claim 1, wherein the non-epoxy mold compound is a thermal plastic.

7. The printhead of claim 1, wherein the non-epoxy mold compound is a polymide.

8. A media wide array, comprising:
a number of printhead dies comprising an upper surface comprising a number of nozzles; and
a layer of moldable material, wherein the moldable material comprises a non-epoxy mold compound overmolded onto the number of printhead dies and wherein the layer of moldable material is flush with the upper surface of the printhead dies.

9. The media wide array of claim 8, wherein the number of printhead dies each comprise a number of slivers.

10. The media wide array of claim 9, wherein a number of ejection fluid slots are defined in the non-epoxy mold compound to feed an ejection fluid to the number of slivers.

11. The media wide array of claim 8, wherein the non-epoxy mold compound comprises a glass, a silicon alloy, a semiconductor material, a ceramic, a metal oxide, a metal, or combinations thereof.

12. The media wide array of claim 8, further comprising a printed circuit board overmolded with the non-epoxy mold compound with the number of printhead dies.

13. A printhead fabrication method, comprising:
placing a number of printhead dies face down on a carrier; and
overmolding the printhead dies on the carrier with a non-epoxy mold compound such that the non-epoxy mold compound is flush with the faces of each of the printhead dies.

14. The printhead fabrication method of claim 12, further comprising placing a printed circuit board on the carrier with the number of printhead dies prior to overmolding the printhead dies.

15. The printhead fabrication method of claim 12, wherein the non-epoxy mold compound comprise one of a glass, a silicon alloy, a semiconductor material, a ceramic, a metal oxide, a metal, or combinations thereof
